(19) United States
(12) Patent Application Publication
(10) Pub. No.: US 2016/0182173 A1
(43) Pub. Date: Jun. 23, 2016

(54) USE OF NAVIGATION ROUTE FOR SMART FM/AM SCANNING

(71) Applicant: Panasonic Automotive Systems Company of America, Division of Panasonic Corporation of North America, Peachtree City, GA (US)

(72) Inventors: ERIC WILLIAMS, ATLANTA, GA (US); ALAN HIGHTOWER, AUSTELL, GA (US)

(73) Assignee: Panasonic Automotive Systems Company of America, Division of Panasonic Corporation of North America

(21) Appl. No.: 14/973,815

(22) Filed: Dec. 18, 2015

Related U.S. Application Data
(60) Provisional application No. 62/094,634, filed on Dec. 19, 2014.

(51) Int. Cl. H04H 40/18; G01C 21/26; H04B 17/318

(52) U.S. Cl. CPC H04H 40/18; H04B 17/318; G01C 21/26

(57) ABSTRACT

A method of operating a vehicle radio system includes the following automatic, computer-implemented steps. A radio is tuned to a first radio station of a particular genre. It is determined that a received signal strength from the first radio station is becoming weaker. Other candidate radio stations of the particular genre are scanned for. Respective broadcast locations of the candidate radio stations are ascertained. One of the candidate radio stations is selected to switch tuning to. The selecting is based upon the ascertained broadcast locations of the candidate radio stations and a planned route of the vehicle received from a navigation system.

### CROSS-REFERENCE TO RELATED APPLICATIONS

This application claims the benefit of U.S. Provisional Application No. 62/094,634, filed on Dec. 19, 2014, which the disclosure of which is hereby incorporated by reference in its entirety for all purposes.

### FIELD OF THE INVENTION

The disclosure relates to a method of operating an automobile radio, and, more particularly, to tuning to a radio station on an automobile radio.

### BACKGROUND OF THE INVENTION

In current vehicle audio systems, the vehicle may eventually go out of the range of the FM station that is being listened to on a road trip. Typically, the user will have to initiate a scan when this happens in order to find a similar station.

When an FM radio station goes out of range, the driver needs to direct his attention to the radio in order to perform a scan. The driver also needs to be attentive to listening to the stations so that he can judge when to stop the scanning.

If driver performs a scan while a particular radio station is playing a commercial, the driver may not have any way to determine whether the station is a desired station. Another problem is that the driver may find and stop at a new station that is similar to the station he was previously listening to, but the new station will not necessarily be the “most” similar station that is currently available.

### SUMMARY

The present invention may provide a smart FM/AM auto-scanner which automatically scans for, finds, and tunes into an FM/AM station that is most similar to the station that the user was most recently listening to before the user's vehicle traveled out of reception range. The scanner may perform the scanning, finding and tuning without any user intervention.

The present invention may provide a car radio that detects that it is going out of the broadcast range of a currently tuned-to station and, in the background, automatically finds similar stations that are in broadcast range. The radio automatically switches to the most similar station without user intervention. Within the context of this invention description, “similar” may mean that the candidate station has roughly the same genre of music or talk as the currently listened-to station. Thus, if the station currently going out of range is a jazz station, then the radio will find another jazz station within the reception range of the vehicle.

The use of information from the planned route in the navigation system enables the recommendation system to be “smarter” by offering new stations based on what new stations will be in range for the longest length of time.

In one embodiment, the smart AM/FM scanner of the invention may base smart recommendations only on the signal strength of a candidate station at a current location and travel direction of the vehicle, assuming that the automobile has a navigation system. The navigation system can be used to better determine which station will be in reception range for the longest length of time based on the route that is planned. The planned route information may also enable the system to more precisely and accurately estimate when vehicle will move out of the broadcast range of the current station.

The invention may comprise, in one form thereof, a method of operating a vehicle radio system, including the following automatic, computer-implemented steps. A radio of the vehicle is tuned to a first radio station of a particular genre. It is determined that a received signal strength from the first radio station is becoming weaker. Other candidate radio stations of the particular genre are scanned for. Respective broadcast locations of the candidate radio stations are ascertained. One of the candidate radio stations is selected to switch tuning to. The selecting is based upon the ascertained broadcast locations of the candidate radio stations and a planned route of the vehicle received from a navigation system.

The invention may comprise, in another form thereof, a method of operating a vehicle radio system, including the following automatic, computer-implemented steps. A radio of the vehicle is tuned to a first radio station of a particular genre. It is determined that a received signal strength from the first radio station is becoming weaker. Other candidate radio stations of the particular genre are scanned for. Respective signal strengths of each of the candidate radio stations are ascertained at a plurality of different locations of the vehicle. One of the candidate radio stations is selected to switch tuning to. The selection is based upon the ascertained signal strengths of the candidate radio stations at the different vehicle locations and a planned route of the vehicle received from a navigation system.

The invention may comprise, in yet another form thereof, a method of operating a vehicle radio system, including the following automatic, computer-implemented steps. A radio of the vehicle is tuned to a first radio station of a particular genre. It is determined that a received signal strength from the first radio station is becoming weaker. Other candidate radio stations of the particular genre are scanned for. Information is extracted from respective broadcast signals from each of the candidate radio stations. One of the candidate radio stations is selected to switch tuning to. The selection is based upon the extracted information from the broadcast signals of the candidate radio stations and a planned route of the vehicle received from a navigation system.

Advantages of the invention are that it may reduce driver distraction and improve the convenience of the audio system.

### BRIEF DESCRIPTION OF THE DRAWINGS

A better understanding of the present invention will be had upon reference to the following description in conjunction with the accompanying drawings.

FIG. 1 is a schematic diagram illustrating one embodiment of a smart FM/AM auto-scanning method of the present invention.

FIG. 2 is a flow chart illustrating another embodiment of a smart FM/AM auto-scanning method of the present invention.

FIG. 3 illustrates an example database of the invention.

FIG. 4 illustrates another example database of the invention.

FIG. 5 is a flow chart illustrating yet another embodiment of a smart FM/AM auto-scanning method of the present invention.

FIG. 6 is a diagram illustrating the selection of a new radio station to tune to according to one embodiment of the present invention.

### DETAILED DESCRIPTION OF THE PREFERRED EMBODIMENTS

The embodiments hereinafter disclosed are not intended to be exhaustive or limit the invention to the precise forms disclosed in the following description. Rather the embodiments are chosen and described so that others skilled in the art may utilize its teachings.

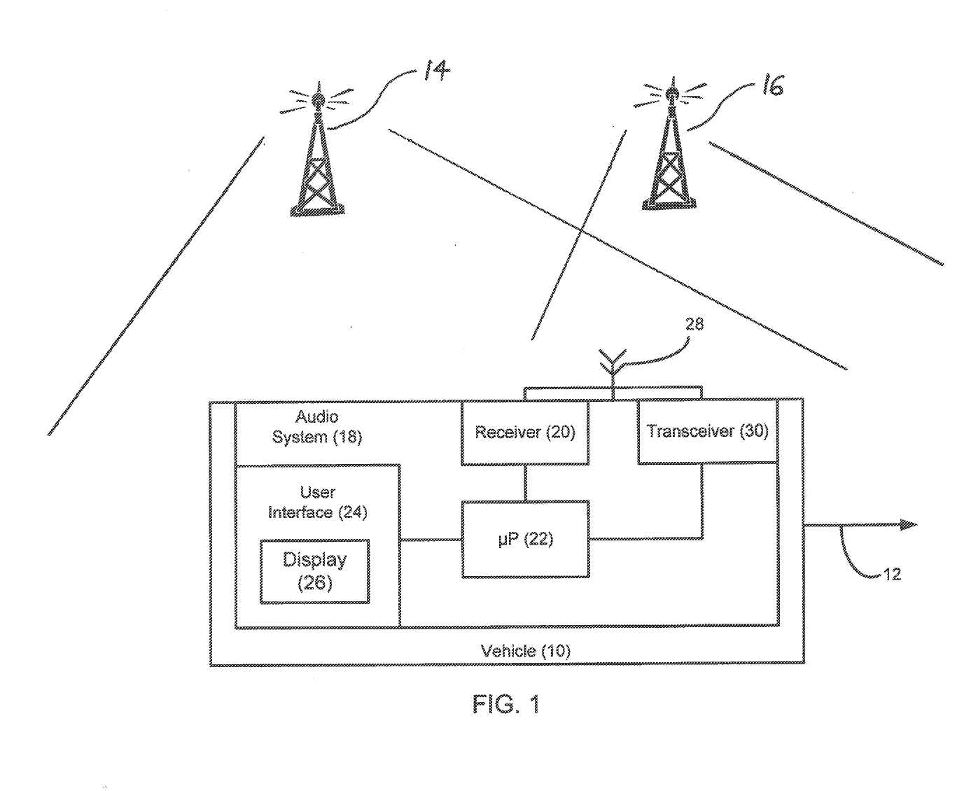

Referring now to the drawings, and particularly to FIG. 1, there is shown a vehicle 10 moving in direction 12. As vehicle 10 continues to move in direction 12, vehicle 10 may move farther away from first radio station 14, and thus may move out of the reception range of first radio station 14. Also as vehicle 10 continues to move in direction 12, vehicle 10 may move closer to a second radio station 16, and thus may move into the reception range of second radio station 16. Second radio station 16 may be similar to first radio station 14 in that stations 14 and 16 broadcast the same genre of music or the same genre of talk.

Vehicle 10 may include an audio system 18 having a radio receiver 20 communicatively coupled to a microprocessor 22 which, in turn, is communicatively coupled to a user interface 24. User interface 24 may include a display 26 with a touch screen that a user may use to make selections of options presented on display 26. Receiver 20 may receive radio signals via antenna 28.

As vehicle 10 leaves the broadcast range of first station 14, audio system 18 may sense that the strength of the signal from station 14 is getting lower. In response to sensing the weakening of the signal from station 14, audio system 18 may identify second station 16 as being similar to station 14. Audio system 18 may include a transceiver 30 including a second receiver for background frequency searching and identification of similar stations. After sensing that first station 14 is getting out of range and identifying similar station 16, audio system 18 may present on display 26 a message such as “Your current station is going out of range. I've found a similar station in range . . . Switch?”. Audio system 18 may also present on display 26 a first touch button labeled “Yes”, and a second touch button labeled “No” with which the user may answer the question about switching. Alternatively, after sensing that first station 14 is getting out of range and identifying the three most similar stations, audio system 18 may present on display 26 a message such as “Your current station is going out of range. Here are the top 3 most similar stations in range”. In one embodiment, this message may be an audible message instead of a visible message. Audio system 18 may also present on display 26 a three touch buttons each labeled with the frequency and/or call letters of a respective one of the three most similar stations. Below each of the touch buttons may be displayed the name of the artist and/or song that is currently playing on that station. By touching one of the touch buttons, the user may switch tuning to the respective similar station.

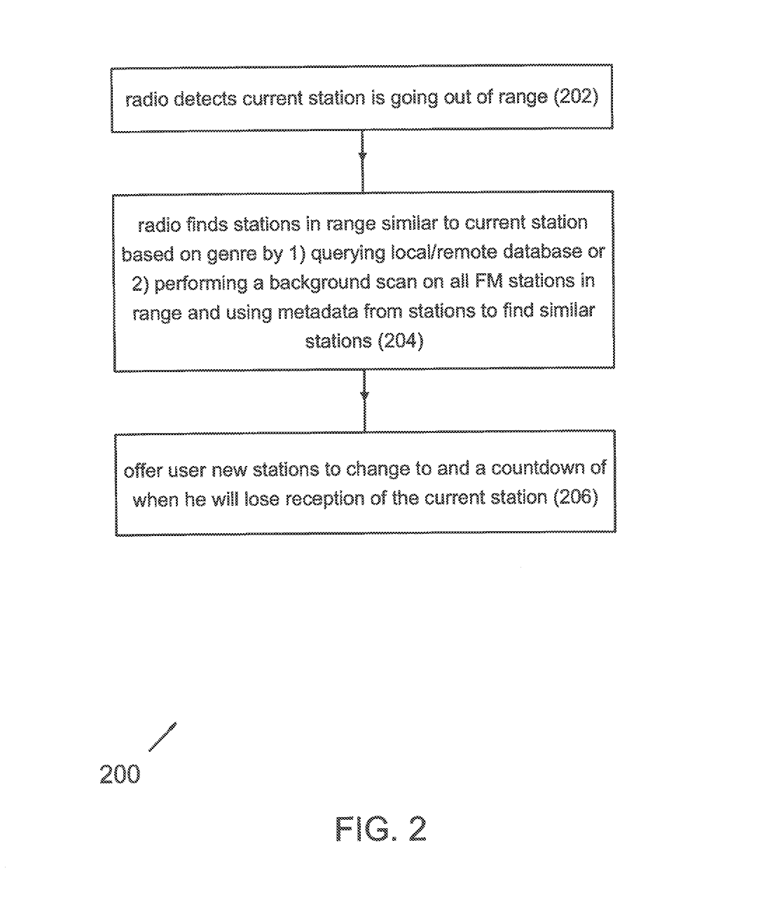

Another embodiment of a smart FM/AM auto-scanning method 200 of the present invention is illustrated in the flow chart of FIG. 2. In a first step 202, a radio detects that a current station is going out of range. For example, audio system 18 may determine that vehicle 10 is moving out of the reception range of first station 14, perhaps by detecting that the signal being received from station 14 is weakening.

In a next step 204, the radio finds stations in range that are similar to the current station in terms of genre by querying a local/remote database, or by performing a background scan on all stations in range and using metadata from all stations in range. For example, audio system 18 may find the three stations that are most similar to the current station by such querying or by performing background scans.

Next, in step 206, the user may be offered new stations to change to, and a countdown to when the user will lose the current station. For example, identifications of the three most similar stations may be presented on display 26, with a selectable respective touch button being presented for each of the stations. Further, a countdown timer may present on display 26 the estimated time in minutes and seconds before the signal from the first station is no longer strong enough to be satisfactorily played on audio system 18.

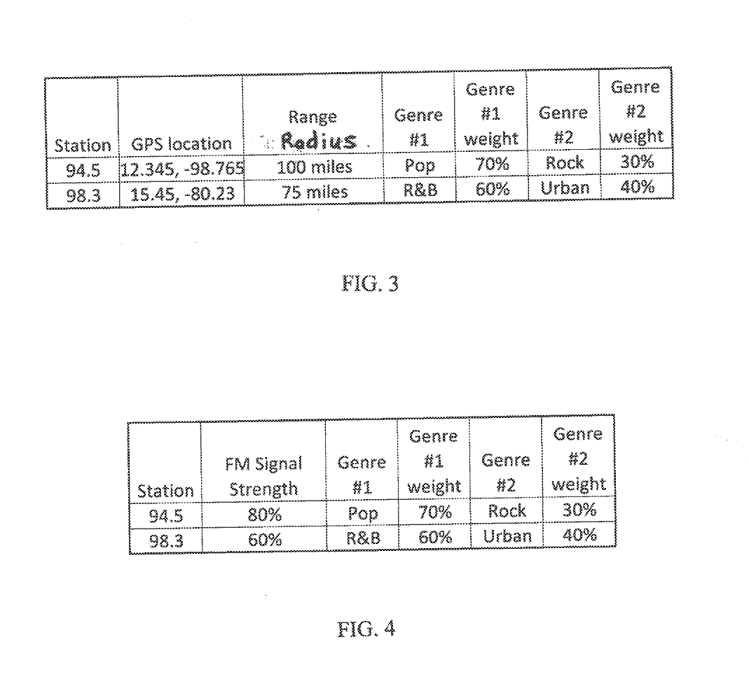

In order to identify one or more stations that are similar to the current station, audio system 18 may refer to and pull information from a database that is located either locally on the radio or in the cloud. FIG. 3 illustrates an example of such a database of the invention. The weights may indicate what percentage of the station's programming is comprised of each genre of music.

In the event that the database is located in the cloud, the database may be dynamic and easily modified. Regardless, however, of whether the database is locally stored in the radio or in the cloud, audio system 18 may transmit the current GPS location of vehicle 10 and the genre of the currently tuned radio station to the database. If the database is in the cloud, transceiver 30 may be used to transmit this information. In response, the database may transmit to audio system 18 information identifying one or more stations that are in range of vehicle 10 and similar to the currently tuned station. Audio system 18 may then present the station-identifying information on display 26 for selection by the user, as described above.

In another embodiment, audio system 18 requests genre metadata from all stations in reception range. Transceiver 30 may be used for these requests. In response, the stations in reception range may return to audio system 18 the requested genre metadata. Audio system 18 may then take the received metadata and create a database (FIG. 4) of the received metadata. Audio system 18 may then present to the user the most similar stations, taking into account genre matching and the signal strength of the similar stations. The weights may indicate what percentage of the station's programming is comprised of each genre of music.

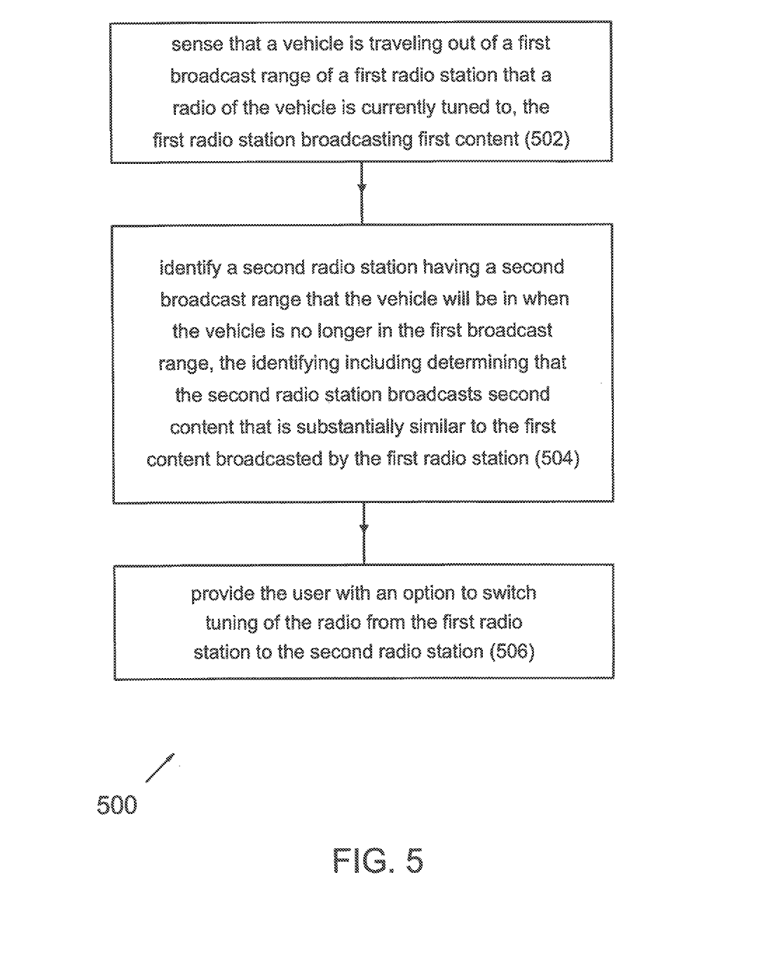

Yet another embodiment of a smart FM/AM auto-scanning method 500 of the present invention is illustrated in the flow chart of FIG. 5. In a first step 502, it is sensed that a vehicle is traveling out of a first broadcast range of a first radio station that a radio of the vehicle is currently tuned to. The first radio station broadcasts first content. For example, audio system 18 may determine that vehicle 10 is moving out of the reception range of first station 14, perhaps by detecting that the signal being received from station 14 is weakening. Alternatively, audio system 18 may determine that vehicle 10 is moving out of the reception range of first station 14 by querying a database, such as the database shown in FIG. 3, to ascertain the broadcast range of first station 14. First station 14 may broadcast content of a certain genre of music or talk, or a certain combination of genres in a certain ratio.

In a next step 504, a second radio station is identified having a second broadcast range that the vehicle will be in when the vehicle is no longer in the first broadcast range. The identifying including determining that the second radio station broadcasts second content that is substantially similar to the first content broadcasted by the first radio station. For example, audio system 18 may find, of the stations that will be in broadcast range, a station that is most similar to the current station by querying a local or remote database, such as the database shown in FIG. 3. Alternatively, audio system 18 may perform a background scan to sample stations whose signals can be received. Audio system 18 may then populate a database, such as the database shown in FIG. 4, with data associated with the sampled stations to thereby ascertain which of the sampled stations both can be adequately received and broadcasts content that is most similar to the content of the currently-tuned station.

In a final step 506, the user may be provided with an option to switch tuning of the radio from the first radio station to the second radio station. For example, a question such as “would you like to switch to a similar station?” may be presented on display 26, with a selectable touch button also being presented on display 26 for the user to provide an affirmative response.

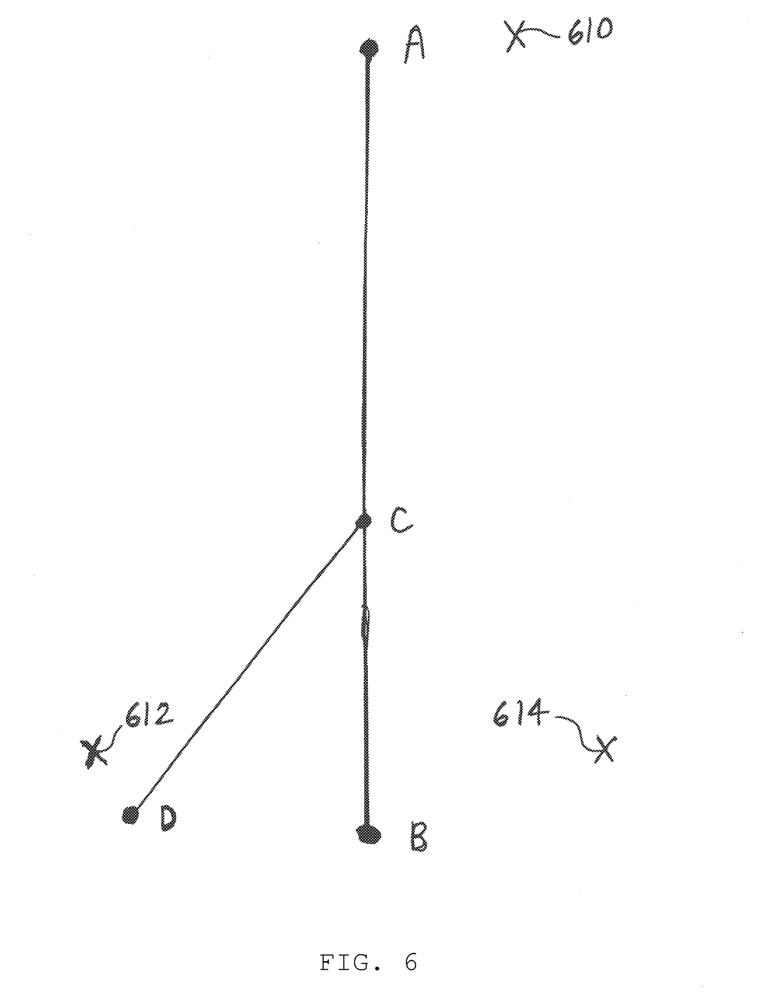

FIG. 6 is an example diagram illustrating a method of selecting a radio station to tune to according to one embodiment of the present invention. Assume a user is traveling in a vehicle equipped with a radio of the invention along a roadway extending at least between points A and B. Also assume that the vehicle includes a navigation system which has programmed a planned route of the vehicle in which the vehicle will travel from point A to point C and at which point the vehicle will exit the above-described roadway and travel to point D along another roadway extending at least between points C and D.

Further assume that as the vehicle is traveling from point A to point C, and when the vehicle is closer to point A than point C, the vehicle is tuned to a first radio station of a certain genre broadcasting from location 610. As the vehicle gets closer to point C, the radio system may detect that the signal from location 610 is getting weaker, and thus the radio system may start searching for candidate alternative radio stations to tune to. The radio system may do some background scanning while still tuned to the first station, and may identify a second radio station broadcasting from location 612 and a third radio station broadcasting from location 614. Both this second station and third station may be of the same genre as the first radio station. The radio system may determine that the second radio station is broadcasting from location 612 and/or that the third radio station is broadcasting from location 614 based on information embedded in the signals from the second and third stations; based on information from a lookup table and an identification of the radio station from its broadcast frequency and/or call letters; or based on changing vehicle location information from the navigation system in conjunction with changing received signal strengths from the stations.

As the vehicle continues to travel toward point C, the radio system may determine that the signals are approximately equally strong from locations 612 and 614, or that the signal from station 614 is slightly stronger than the signal from station 612. However, the radio system may be in communication with the navigation system, or the radio system and the navigation system may be built integrally together as one single system. The radio system may then receive information from the navigation system indicating that the vehicle will be traveling to point D. Hence, the radio system, perhaps in conjunction with the navigation system, may determine that location 612 is closer than location 614 to the roadway from point C to point D. Based on the proximity of location 612 to the roadway between points C and D, the radio system may determine that the received signal strength from location 612 will likely be greater than the received signal strength from location 614 while the vehicle travels from point C to point D. Accordingly, when the signal strength from location 610 becomes sufficiently weak, the radio system may automatically switch tuning from the station at location 610 to the station at location 612. This switching of radio stations may be made either before or after the vehicle has passed through point C. Although the signals from locations 612 and 614 may both provide adequate signal strength around point C, it may be determined that the signal from location 612 will remain adequate for a longer length of time than the signal from location 614 as the vehicle progresses from point C to point D.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A method of operating a vehicle radio system, comprising the automatic, computer-implemented steps of:
tuning a radio to a first radio station of a particular genre;
determining that a received signal strength from the first radio station is becoming weaker;
scanning for other candidate radio stations of the particular genre;
ascertaining respective broadcast locations of the candidate radio stations; and
selecting one of the candidate radio stations of the particular genre to switch tuning to, the selecting being based upon the ascertained broadcast locations of the candidate radio stations and a planned route of the vehicle received from a navigation system.

2. The method of claim 1, wherein the determining step is performed by the radio.

3. The method of claim 1, wherein the radio includes a first tuner and a second tuner, the tuning step being performed by the first tuner, the scanning step being performed by the second tuner.

4. The method of claim 1, wherein the ascertaining step includes extracting information from respective broadcast signals from each of the candidate radio stations.

5. The method of claim 1, wherein the ascertaining step includes detecting changes in signal strengths of the candidate radio stations as the vehicle travels along the planned route.

6. The method of claim 1, wherein the selected one of the candidate radio stations is selected based upon being closer to at least a portion of the planned route of the vehicle than any of the other candidate radio stations of the particular genre.

7. The method of claim 6, wherein the selected one of the candidate radio stations is selected based upon being closer than any of the other candidate radio stations of the particular genre to at least a portion of the planned route that the vehicle is planned to traverse after the selecting step.

8. A method of operating a vehicle radio system, comprising the automatic, computer-implemented steps of:
tuning a radio of the vehicle to a first radio station of a particular genre;
determining that a received signal strength from the first radio station is becoming weaker;
scanning for other candidate radio stations of the particular genre;
ascertaining respective signal strengths of each of the candidate radio stations at a plurality of different locations of the vehicle; and
selecting one of the candidate radio stations to switch tuning to, the selecting being based upon the ascertained signal strengths of the candidate radio stations at the different vehicle locations and a planned route of the vehicle received from a navigation system.

9. The method of claim 8, wherein the determining step is performed by the radio.

10. The method of claim 8, wherein the radio includes a first tuner and a second tuner, the tuning step being performed by the first tuner, the scanning step being performed by the second tuner.

11. The method of claim 8, wherein the ascertaining step includes extracting information from respective broadcast signals from each of the candidate radio stations.

12. The method of claim 8, wherein the ascertaining step includes detecting changes in signal strengths of the candidate radio stations as the vehicle travels along the planned route.

13. The method of claim 8, wherein the selected one of the candidate radio stations is selected based upon being closer to at least a portion of the planned route of the vehicle than any of the other candidate radio stations of the particular genre.

14. The method of claim 13, wherein the selected one of the candidate radio stations is selected based upon being closer than any of the other candidate radio stations of the particular genre to at least a portion of the planned route that the vehicle is planned to traverse after the selecting step.

15. A method of operating a vehicle radio system, comprising the automatic, computer-implemented steps of:
tuning a radio of the vehicle to a first radio station of a particular genre;
determining that a received signal strength from the first radio station is becoming weaker,
scanning for other candidate radio stations of the particular genre;
extracting information from respective broadcast signals from each of the candidate radio stations; and
selecting one of the candidate radio stations to switch tuning to, the selecting being based upon the extracted information from the broadcast signals of the candidate radio stations and a planned route of the vehicle received from a navigation system.

16. The method of claim 15, wherein the determining step is performed by the radio.

17. The method of claim 15, wherein the radio includes a first tuner and a second tuner, the tuning step being performed by the first tuner, the scanning step being performed by the second tuner.

18. The method of claim 15, wherein the ascertaining step includes detecting changes in signal strengths of the candidate radio stations as the vehicle travels along the planned route.

19. The method of claim 15, wherein the selected one of the candidate radio stations is selected based upon being closer to at least a portion of the planned route of the vehicle than any of the other candidate radio stations of the particular genre.

20. The method of claim 19, wherein the selected one of the candidate radio stations is selected based upon being closer than any of the other candidate radio stations of the particular genre to at least a portion of the planned route that the vehicle is planning to traverse after the selecting step.
